(19) United States
(12) Patent Application Publication
(10) Pub. No.: US 2002/0156762 A1
(43) Pub. Date: Oct. 24, 2002

(54) Method for selecting a wireless data transmitter

(75) Inventor: Ping-Ying Chu, Tainan (TW)

Correspondence Address: Richard P. Berg, Esq., c/o LADAS & PARRY, Suite 2100, 5670 Wilshire Boulevard, Los Angeles, CA, 90036-5679, US

(73) Assignee: Winbond Electronics Corp.

(21) Appl. No.: 09/939,107

(22) Filed: Aug. 24, 2001

(30) Foreign Application Priority Data
Apr. 20, 2001 (TW) 90109562

(51) Int. Cl. G06F 7/00

(52) U.S. Cl. 707/1

(57) ABSTRACT

A method for selecting a wireless data transmitter to convey digital data from a first device to a second device. The first device has a transmitter and the second device has a receiver. A sole authentication number is assigned to the first device. A signal including the authentication number is conveyed from the transmitter of the first device and a login number corresponding to the authentication number is displayed on the second device when the receiver of the second device locates the signal. The login number is input into the first device, and the login number is then conveyed from the transmitter to the receiver such that the digital data from the first device is received by the second device.

### BACKGROUND OF THE INVENTION

1. Field of the Invention

The present invention relates to data transfer, and more particularly to a method for selecting a wireless data transmitter.

2. Background

Dimensions of computers and their peripherals are gradually reducing, with the progression of technology. Conventional connections between computers and their peripherals are generally via bus, twist wire or cable, with conduction wires to transfer data. In order to increase convenience, wireless transfer technologies have also been developed. Because wireless transmission is easily moveable, the products of the wireless transmission are gaining a great deal of popularity.

One of the properties of wireless transmission is that signals of the same band stored in a transfer range conveyed from distinct transmitters will be received by a receiver. Consequently, unwanted signals may be received by the receiver, thus resulting in reception errors. Suppliers of wireless devices always provide a matched pair of transmitter and receiver to avoid the above-mentioned problem. With distinct bands or coding to separate various signals, disturbances can be avoided. However, the condition still occurs, wherein transmitters of the same type made by one producer will disturb receivers of the same type. Transmitters and receivers made by multiple producers are not compatible, thus prices are high. Moreover, when one of the pair is damaged, a new pair must be supplied.

### SUMMARY OF THE INVENTION

The object of the present invention is to solve the above-mentioned problems and to provide a method for selecting a wireless data transmitter. An advantage of the present invention is that any transmitting signal can be chosen by the receiver, and unwanted signals can be avoided. Furthermore, transmitters and receivers can be made and sold separately to reduce costs.

According to the present invention, a method for selecting a wireless data transmitter is disposed, to convey digital data from a first device to a second device, wherein the first device has a transmitter and the second device has a receiver, comprising the following steps. First, a sole authentication number is assigned to the first device. Next, a signal including the authentication number is conveyed from the transmitter of the first device. A login number corresponding to the authentication number is displayed on the second device when the receiver of the second device locates the signal. Finally, the login number is input into the first device, and the login number is then conveyed from the transmitter to the receiver such that the digital data from the first device is received by the second device.

### BRIEF DESCRIPION OF THE DRAWINGS

The present invention will be described in detail with reference to the illustrated embodiments and the accompany drawings, in which:

FIG. 1 is a block diagram of the wireless data transmission system in embodiment 1.

FIG. 2 is a flow chart showing the steps for selecting a wireless data transmitter in embodiment 1.

FIG. 3 is a block diagram of the wireless data transmission system in embodiment 2.

FIG. 4 is a flow chart showing the steps for selecting a wireless data transmitter in embodiment 2.

FIG. 5 is a block diagram of the wireless data transmission system in embodiment 3.

FIG. 6 is a flow chart showing the steps for selecting a wireless data transmitter in embodiment 3.

### DETAILED DESCRIPTION OF THE PREFERRED EMBODIMENT

A method for selecting a wireless data transmitter according to the preferred embodiments of the present invention will now be described.

The method for selecting a wireless data transmitter, according to the preferred embodiment of the present invention, is used for wireless exchange of digital data between electric devices.

Embodiment 1

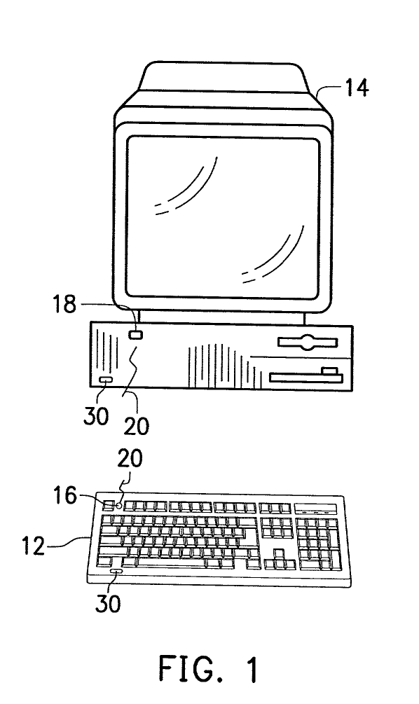

FIG. 1 is a block diagram of the wireless data transmission system in embodiment 1. As shown in FIG. 1, the system is from the group consisting of a first device 12 and a second device 14, wherein the first device 12 has a transmitter 16 and the second device 14 has a receiver 18. The first device 12 is from the group consisting of a keyboard, mouse, personal gaming device, cellular phone, personal digital assistant, set-top box, notebook computer, computer and IA (Internet Appliance). The second device 14 is from the group consisting of a personal gaming device, cellular phone, personal digital assistant, set-top box, notebook computer, computer and IA. The first device 12 of embodiment 1 is a keyboard, and the second device 14 is a computer by way of example. Transmission between the transmitter 16 and the receiver 18 uses radio waves 20 from the group consisting of high frequency radio, infrared and microwave. The first device 12 has a sole authentication number stored in EEPROM (electrically erasable programmable read-only memory) 30.

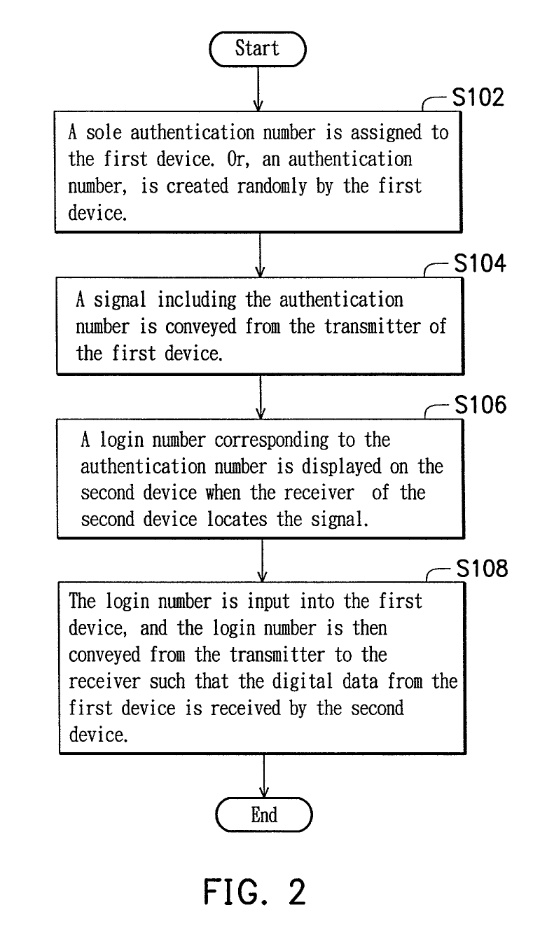

In FIG. 2 a flow chart shows the steps for selecting a wireless data transmitter in this invention. In embodiment 1, the digital data is conveyed from a single first device to a single second device by way of wireless transmission. The process first assigns a sole authentication number to the first device 12, as shown in step S102. A sole authentication number can be stored in EEPROM 30. Or, an authentication number, greater than a 16-bit number, is created randomly by the first device 12.

In step S104, a signal including the authentication number is conveyed from the transmitter 16 of the first device 12.

In step S106, a login number corresponding to the authentication number is displayed on the second device 14 when the receiver 18 of the second device 14 locates the signal.

Finally, in step S108, the login number is input into the first device 12, and the login number is then conveyed from the transmitter 16 to the receiver 18 such that the digital data from the first device 12 is received by the second device 14.

Embodiment 2

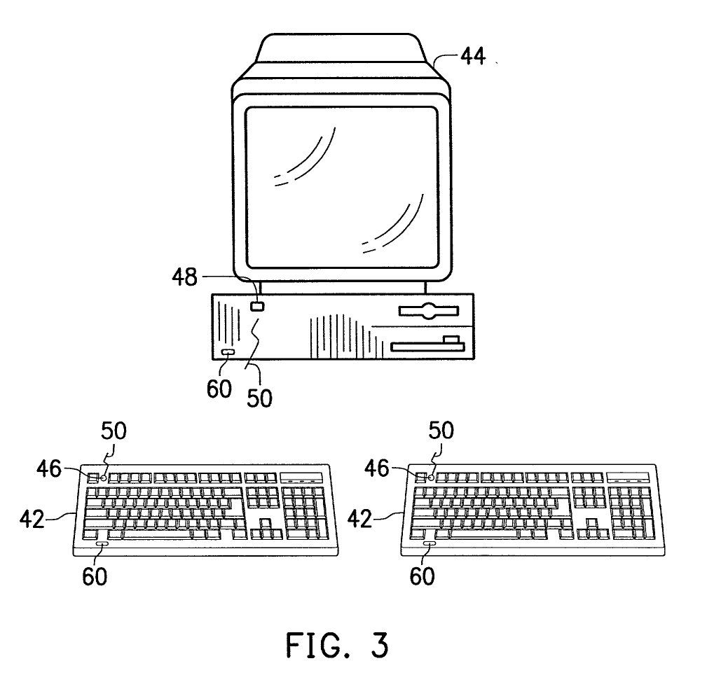

FIG. 3 is a block diagram of the wireless data transmission system in embodiment 2. As shown in FIG. 3, the system consists of a plurality of first devices 42 and a second device 44, wherein each of the first devices 42 has an individual transmitter 46 and the second device 44 has a receiver 48. The first device 42 is from the group consisting of a keyboard, mouse, personal gaming device, cellular phone, personal digital assistant, set-top box, notebook computer, computer and IA. The second device 44 is from the group consisting of a personal gaming device, cellular phone, personal digital assistant, set-top box, notebook computer, computer and IA. The first devices 42 of embodiment 2 are two keyboards, and the second device 44 is a computer by way of example. Transmission between the transmitters 46 and the receiver 48 can use radio waves 50 from the group consisting of high frequency radio, infrared and microwave. The first devices 42 each have a sole authentication number stored in individual EEPROM 60.

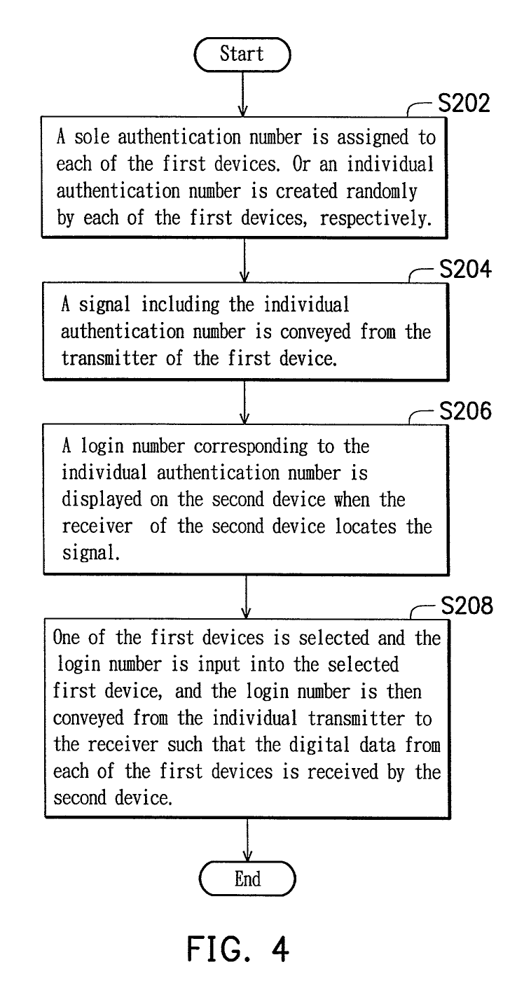

In FIG. 4 a flow chart shows the steps for selecting a wireless data transmitter in this invention. In embodiment 2 the digital data is conveyed from a plurality of first devices to a single second device by way of wireless transmission. The process first assigns a sole authentication number to each of the first devices 42, as shown in step S202. A sole authentication number can be stored in EEPROM 60, or an individual authentication number, greater than a 16-bit number, is created randomly by each of the first devices 42, respectively.

In step S204, a signal including the individual authentication number is conveyed from the transmitter 46 of the first device 42.

In step S206, a login number corresponding to the individual authentication number is displayed on the second device 44 when the receiver 48 of the second device 44 locates the signal.

Finally, in step S208, one of the first devices 42 is selected and the login number is input into the selected first device 42, and the login number is then conveyed from the individual transmitter 46 to the receiver 48 such that the digital data from each of the first devices 42 is received by the second device 44.

Embodiment 3

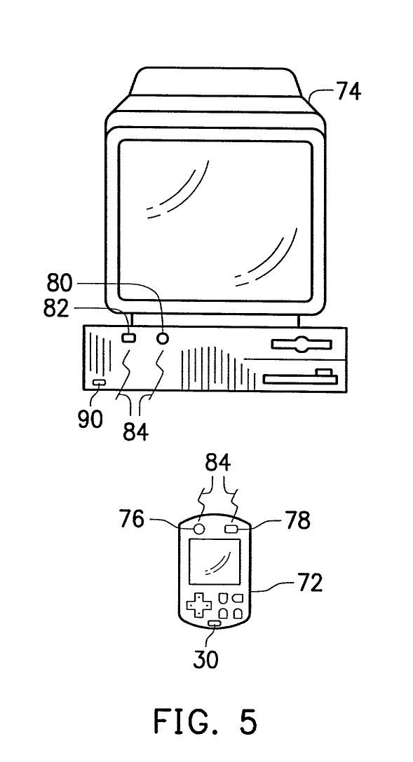

FIG. 5 is a block diagram of the wireless data transmission system in embodiment 3. As shown in FIG. 5, the system consists of a first device 72 and a second device 74, wherein the first device 72 has a first transmitter 76 and a first receiver 78, and the second device 74 has a second transmitter 80 and a second receiver 82. The first device 72 is from the group consisting of a personal gaming device, cellular phone, personal digital assistant, set-top box, notebook computer, computer and IA. The second device 74 is from the group consisting of a personal gaming device, cellular phone, personal digital assistant, set-top box, notebook computer, computer and IA. The first device 72 of embodiment 3 is a PDA, and the second device 74 is a computer by way of example. Transmission between the transmitter 76 or 80 and the receiver 78 or 82 can use radio waves 84 such as high frequency radio, infrared and microwave. The first device 72 and the second device 74 each have a sole authentication number stored in EEPROM (electrically erasable programmable read-only memory) 90.

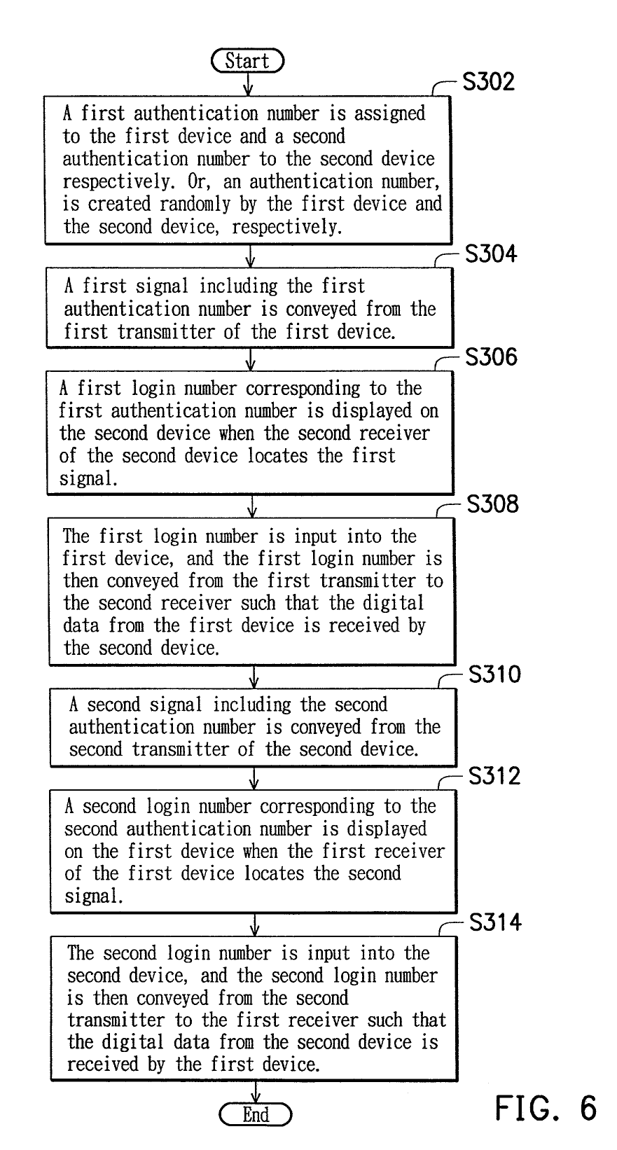

In FIG. 6 a flow chart shows the steps for selecting a wireless data transmitter in this invention. In embodiment 3 the digital data is exchanged, bi-directionally, between a single first device and a single second device by way of wireless transmission. The process first assigns a first authentication number to the first device 72 and a second authentication number to the second device 74, respectively, as shown in step S302. A sole authentication number can be stored in EEPROM 90. Or, an authentication number, greater than a 16-bit number, is created randomly by the first device 72 and the second device 74, respectively.

In step S304, a first signal including the first authentication number is conveyed from the first transmitter 76 of the first device 72.

In step S306, a first login number corresponding to the first authentication number is displayed on the second device 74 when the second receiver 82 of the second device 74 locates the first signal.

In step S308, the first login number is input into the first device 72, and the first login number is then conveyed from the first transmitter 76 to the second receiver 82 such that the digital data from the first device 72 is received by the second device 74.

In step S310, a second signal including the second authentication number is conveyed from the second transmitter 80 of the second device 74.

In step S312, a second login number corresponding to the second authentication number is displayed on the first device 72 when the first receiver 78 of the first device 72 locates the second signal.

Finally, in step S314, the second login number is input into the second device 74, and the second login number is then conveyed from the second transmitter 80 to the first receiver 78 such that the digital data from the second device 74 is received by the first device 72.

The method for selecting a wireless data transmitter, according to the present invention, has an advantage in that any transmission signals can be chosen by receivers, and unwanted signals can be avoided. Furthermore, transmitters and receivers can be made and sold separately to reduce cost.

Wherein the invention has been described with reference to various illustrative embodiments, the description is not intended to be construed in a limiting sense. Various modifications of the illustrative embodiments, as well as other embodiments of the invention, will be apparent to those persons skilled in the art upon reference to this description. It is therefore contemplated that the appended claims will cover any such modifications or embodiments as may fall stored in the scope of the invention defined by the following claims and their equivalents.

What is claimed is:

1. A method for selecting a wireless data transmitter, for conveying digital data from a first device to a second device, wherein the first device has a transmitter and the second device a receiver, comprising the steps of:
assigning the first device an authentication number;
the transmitter of the first device conveying a signal including the authentication number;
displaying a login number corresponding to the authentication number on the second device when the receiver of the second device locates the signal; and
inputting the login number into the first device, the transmitter then conveying the login number to the receiver such that the second device receiving the digital data from the first device.

2. The method as recited in claim 1, wherein transmission between the transmitter and the receiver uses radio waves selected from the group consisting of high frequency radio, infrared and microwave.

3. The method as recited in claim 1, wherein the first device is selected from the group consisting of keyboard, mouse, personal gaming device, cellular phone, personal digital assistant, set-top box, notebook computer, computer and IA.

4. The method as recited in claim 1, wherein the second device is selected from the group consisting of personal gaming device, cellular phone, personal digital assistant, set-top box, notebook computer, computer and IA.

5. The method as recited in claim 1, wherein the authentication number is stored in EEPROM (electrically erasable programmable read-only memory).

6. A method for selecting a wireless data transmitter, for conveying digital data from a first device to a second device, wherein the first device has a transmitter and the second device has a receiver, comprising the steps of:
the first device randomly creating an authentication number;
the transmitter of the first device conveying a signal including the authentication number;
displaying a login number corresponding to the authentication number on the second device when the receiver of the second device locates the signal; and
inputting the login number into the first device, the transmitter then conveying the login number to the receiver such that the second device receiving the digital data from the first device.

7. The method as recited in claim 6, wherein transmission between the transmitter and the receiver uses radio waves selected from the group consisting of high frequency radio, infrared and microwave.

8. The method as recited in claim 6, wherein the first device is selected from the group consisting of keyboard, mouse, personal gaming device, cellular phone, personal digital assistant, set-top box, notebook computer, computer and IA.

9. The method as recited in claim 6, wherein the second device is selected from the group consisting of personal gaming device, cellular phone, personal digital assistant, set-top box, notebook computer, computer and IA.

10. A method for selecting a wireless data transmitter, for conveying digital data from a plurality of first devices to a second device, wherein each of the first devices has an individual transmitter and the second device has a receiver, comprising the steps of:
assigning each of the first devices an individual authentication number respectively;
the individual transmitter of each of the first devices conveying a signal including the individual authentication number respectively;
displaying a login number corresponding to the individual authentication number on the second device when the receiver of the second device locates the signal; and
selecting one of the first devices and inputting the login number into the selected first device, the individual transmitter then conveying the login number to the receiver such that the second device receiving the digital data from the selected first device.

11. The method as recited in claim 10, wherein transmission between the transmitter and the receiver uses radio waves selected from the group consisting of high frequency radio, infrared and microwave.

12. The method as recited in claim 10, wherein the first device is selected from the group consisting of keyboard, mouse, personal gaming device, cellular phone, personal digital assistant, set-top box, notebook computer, computer and IA.

13. The method as recited in claim 10, wherein the second device is selected from the group consisting of personal gaming device, cellular phone, personal digital assistant, set-top box, notebook computer, computer and IA.

14. The method as recited in claim 10, wherein the authentication number is stored in EEPROM (electrically erasable programmable read-only memory).

15. A method for selecting a wireless data transmitter, for conveying digital data from a plurality of first devices to a second device, wherein each of the first devices has an individual transmitter and the second device has a receiver, comprising the steps of:
each of the first devices creating randomly an individual authentication number respectively;
the individual transmitter of each of the first devices conveying a signal including the individual authentication number respectively;
displaying a login number corresponding to the individual authentication number on the second device when the receiver of the second device locates the signal; and
selecting one of the first devices and inputting the login number into the selected first device, the individual transmitter then conveying the login number to the receiver such that the second device receiving the digital data from the selected first device.

16. The method as recited in claim 15, wherein Transmission between the transmitter and the receiver uses radio waves selected from the group consisting of high frequency radio, infrared and microwave.

17. The method as recited in claim 15, wherein the first device is selected from the group consisting of keyboard, mouse, personal gaming device, cellular phone, personal digital assistant, set-top box, notebook computer, computer and IA.

18. The method as recited in claim 15, wherein the second device is selected from the group consisting of personal gaming device, cellular phone, personal digital assistant, set-top box, notebook computer, computer and IA.

19. A method for selecting a wireless data transmitter, for exchanging digital data between a first device and a second device, wherein the first device having a first transmitter and a first receiver, and the second device having a second transmitter and a second receiver, comprising the steps of:
assigning the first device a first authentication number and the second device a second authentication number, respectively;
the first transmitter of the first device conveying a first signal including the first authentication number;
displaying a first login number corresponding to the first authentication number on the second device when the second receiver of the second device locates the first signal;
inputting the first login number into the first device, the first transmitter then conveying the first login number to the second receiver such that the second device receiving the digital data from the first device;
the second transmitter of the second device conveying a second signal including the second authentication number;
displaying a second login number corresponding to the second authentication number on the first device when the first receiver of the first device locates the second signal; and
inputting the second login number into the second device, the second transmitter then conveying the second login number to the first receiver such that the first device receiving the digital data from the second device.

20. The method as recited in claim 19, wherein transmission between the transmitter and the receiver uses radio waves selected from the group consisting of high frequency radio, infrared and microwave.

21. The method as recited in claim 19, wherein the first device is selected from the group consisting of personal gaming device, cellular phone, personal digital assistant, set-top box, notebook computer, computer and IA.

22. The method as recited in claim 19, wherein the second device is selected from the group consisting of personal gaming device, cellular phone, personal digital assistant, set-top box, notebook computer, computer and IA.

23. The method as recited in claim 19, wherein the authentication number is stored in EEPROM (electrically erasable programmable read-only memory).

24. A method for selecting a wireless data transmitter, for exchanging digital data between a first device and a second device, wherein the first device has a first transmitter and a first receiver, and the second device has a second transmitter and a second receiver, comprising the steps of:
the first device randomly creating a first authentication number and the second device randomly creating a second authentication number, respectively;
the first transmitter of the first device conveying a first signal including the first authentication number;
displaying a first login number corresponding to the first authentication number on the second device when the second receiver of the second device locates the first signal;
inputting the first login number into the first device, the first transmitter then conveying the first login number to the second receiver such that the second device receiving the digital data from the first device;
the second transmitter of the second device conveying a second signal including the second authentication number;
displaying a second login number corresponding to the second authentication number on the first device when the first receiver of the first device locates the second signal; and
inputting the second login number into the second device, the second transmitter then conveying the second login number to the first receiver such that the first device receives the digital data from the second device.

25. The method as recited in claim 24, wherein transmission between the transmitter and the receiver uses radio waves selected from the group consisting of high frequency radio, infrared and microwave.

26. The method as recited in claim 24, wherein the first device is selected from the group consisting of personal gaming device, cellular phone, personal digital assistant, set-top box, notebook computer, computer and IA.

27. The method as recited in claim 24, wherein the second device is selected from the group consisting of personal gaming device, cellular phone, personal digital assistant, set-top box, notebook computer, computer and IA.
